(19) United States
(12) Patent Application Publication
(10) Pub. No.: US 2003/0154329 A1
(43) Pub. Date: Aug. 14, 2003

(54) Service providing system

(75) Inventors: Koji Ooi, Kanazawa-shi (JP); Ken Ikoma, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/359,956

(22) Filed: Feb. 6, 2003

(30) Foreign Application Priority Data
Feb. 7, 2002 (JP) P. 2002-031131

(51) Int. Cl. G06F 3/00

(52) U.S. Cl. 710/1

(57) ABSTRACT

The present invention provides a service providing system for providing a user with services in accordance with travel history information of the user indicating the location the user was present and the date/time the user was present, and the system includes a terminal having a travel history information transmitter for transmitting the travel history information and a service information output section for outputting information on the services, and a service information management server having a travel history information storage for storing the travel history information transmitted from the personal authentication terminal, a service information storage for storing information on the services, and a service information transmitter for transmitting information on the services to the personal authentication terminal.

### BACKGROUND OF THE INVENTION

1. Field of the Invention

The present invention relates to a service providing system for providing services on a per user basis.

2. Description of the Related Art

An information providing method adaptable to individuals using personal authentication and related apparatus are disclosed in the Japanese Unexamined Patent Publication No. 2001-266002. In the disclosure, a service management table where the types of services provided per user and service providing conditions for providing the services are described is stored in the information providing apparatus adaptable to individuals. Once the user is authenticated as an authorized user, the services granted to an authorized user is provided to the user based on the service management table.

However, this information providing apparatus adaptable to individuals provides services based on the personal information of the authorized user when the user is authenticated as an authorized user, but the apparatus cannot provide services based on the time and location of authentication which are information other than the personal information of the user.

### SUMMARY OF THE INVENTION

The present invention has been proposed to provide the user with new services not found in the related art and aims at providing a service providing system which can provide services per user in accordance with the travel history information indicating the location the user was present and the time the user was present.

A service providing system according to the invention is a service providing system for providing a user with services in accordance with travel history information of the user indicating the location the user was present and the date/time the user was present, and the system includes a terminal having travel history information transmission means for transmitting the travel history information and service information output means for outputting information on the services, and a server having travel history information storage means for storing the travel history information transmitted from the terminal, service information storage means for storing information on the services, and service information transmission means for transmitting information on the services to the terminal.

According to the invention, it is possible to provide the user with services in accordance with the travel history information of the user indicating the location the user was present and the date/time the user was present.

The service information transmission means owned by the server may transmit information on the services to the terminal when the travel history information has satisfied the conditions specified by the provider of information on the services.

According to the invention, it is possible to provide the user with services in accordance with the corresponding travel history information by the travel history information having satisfied the conditions specified by the provider of information on the services. That is, the service provider lets the user take arbitrary action by specifying conditions.

Further, the information on the service may be a presence proof service to prove location the user was present and the date/time the user was present.

### BRIEF DESCRIPTION OF THE DRAWINGS

FIG. 1 is a block diagram of a service providing system 1 according to this embodiment;

FIG. 2 is a block diagram of the internal configuration of the personal authentication terminal 2;

FIG. 3 is a block diagram of the internal configuration of the service information management server 3; and

FIG. 4 shows the configuration of the travel history information table 41.

### DETAILED DESCRIPTION OF THE EMBODIMENT

An embodiment of the invention will be described referring to drawings.

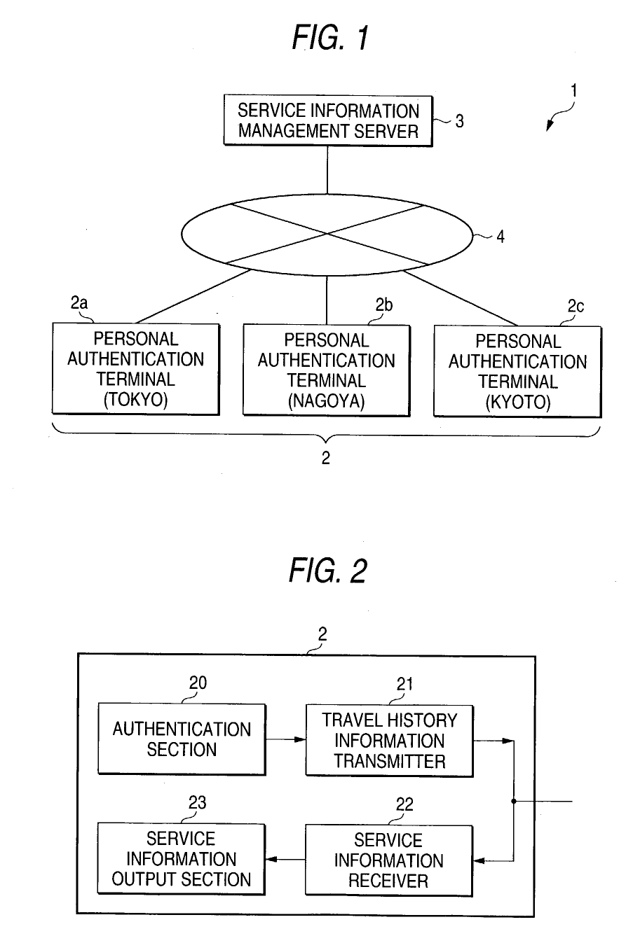

FIG. 1 is a block diagram of a service providing system 1 according to this embodiment.

The service providing system 1 comprises a plurality of personal authentication terminals 2 and a service information management server 3 for managing information on services provided to the user of this system. The personal authentication terminals 2 and the service information management server 3 are connected in a communicable way via a network 4 such as the internet. The personal authentication terminals 2 are arranged nationwide. In this embodiment, it is assumed that the personal authentication terminals 2a, 2b, 2c are arranged at three locations, Tokyo, Nagoya and Kyoto that each personal authentication terminal is assigned an identification number indicating its location.

The following explains a simple flow by which the user uses the service providing system 1. The user registers his/her personal information such as a password to indicate an individual, iris information, fingerprint information, face information and/or voiceprint information with the service information management server 3. After the registration, when it is authenticated that the user is an authorized user for example by the user's input of a password registered with the personal authentication terminal 2, the user's travel history information is transmitted to the service information management server 3. Then, the service information according to the travel history information is transmitted to the password registered with the personal authentication terminal 2, and the user is provided with the service. Incidentally, the user's travel history information includes the date/time of authentication, location and the user ID.

FIG. 2 is a block diagram of the internal configuration of the personal authentication terminal 2.

The personal authentication terminal 2 includes an authentication section 20 for authenticating whether the user is an authorized user with reference to the personal information of the authorized users registered in the service information management server 3, a travel history information transmitter 21 for transmitting the user's travel history information to the service information management server 3, a service information receiver 22 for receiving the service information transmitted from the service information management server 3, and a service information output section 23 for outputting the received service information.

To authenticate the user in the authentication section 20, authentication by way of a password and authentication through biometrics such as iris authentication, fingerprint authentication, face authentication or voiceprint authentication may be used. The service information output form of the service information output section 23 maybe display of text information, output of audio information, or output of a medium such as paper where service information is recorded.

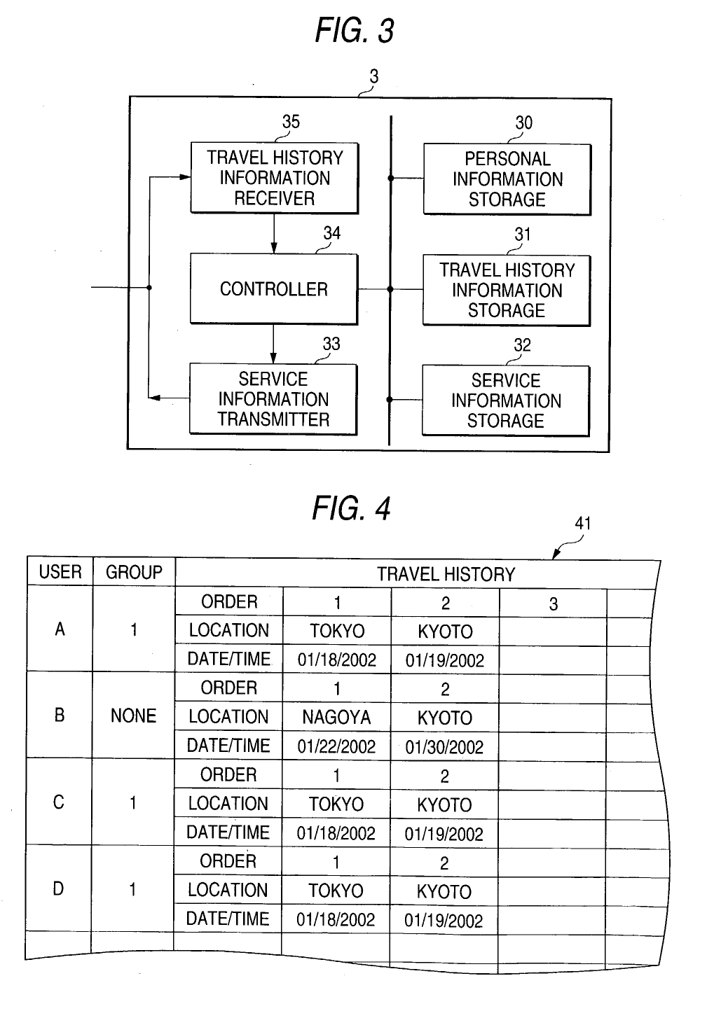

FIG. 3 is a block diagram of the internal configuration of the service information management server 3.

The service information management server 3 includes a personal information storage 30 for storing personal information of the user, a travel history information storage 31 for storing travel history information transmitted from the personal authentication terminal 2 on a per user basis, a service information storage 32 for storing information on the service provided to the user and service providing conditions necessary for providing the services, a service information transmitter 33 for transmitting service information provided to the user to the service information receiver 22, a controller 34 for determining whether the travel history information stored in the travel history information storage 31 satisfies the service providing conditions and, in case the information does, making control to transmit service information according to the service providing conditions to the service information receiver 22 via the service information transmitter 33, and a travel history information receiver 35 for receiving travel history information transmitted from the travel history information transmitter 21.

The service information transmitter 33 and the controller 34 act as a service information transmission unit. The controller 34 also makes control to store the information received by the information receiver 35 into the information storage 31.

Information stored in the travel history information 31 will be detailed. The information storage 31 stores a travel history information table 41 including the items “user,” “group” and “travel history.” FIG. 4 shows the configuration of the travel history information table 41. In the item “user,” the name of the users pre-registered with the service providing system 1. In the item “group,” the group number used when the users have registered a group. Here, the user may register the group simultaneously when he/she registers personal information with the service information management server 3. A plurality of users may be registered as a single group.

The item “travel history” is subdivided into the items “location” and “date/time.” In the item “location,” a location the user was authenticated on the personal authentication terminal 2 is stored. In the item “date/time,” the date and time, that is, year, month, day and hour, the user was authenticated on the personal authentication terminal 2 are stored. In the items “location” and “date/time,” information is stored in the chronological order of user authentication on the personal authentication terminal 2. Which user is the user is determined based on the user ID transmitted from the travel history information transmitter 21.

The controller 34 recognizes that the user A traveled to Kyoto between Jan. 2, 2002 and Jan. 30, 2002 and that the user A and the user C belong to the same group by referencing the travel history information table 41 shown in FIG. 4.

The travel history information storage 31 also stores a distance table which associates the location of each personal authentication terminal 2 and the distance between the personal authentication terminals 2. By referencing this table, it is possible to determine how far the user has traveled.

Next, a specific example of the service information and service providing conditions required to provide the service stored in the service information storage 32 will be described.

Services provided to the user includes for example a presence proof service to prove that the user was present at the location of authentication at the date and time of authentication, a present service to give award a prize to the user, a discount service to discount the trip charge for the user, or a prize contest entrance service to allow entrance to a prize contest.

Next, specific examples of service providing conditions will be listed. When these conditions are satisfied, various services mentioned earlier are provided to the users.

1. The users kept a travel history record in Nagoya between Jan. 1, 2002 and Jan. 31, 2002.

2. The users kept a total of three travel history records in Kyoto.

3. The users kept travel history records in Tokyo and Kyoto.

4. The users kept travel history records in at least two locations out of Tokyo, Nagoya and Kyoto and the total travel distance is 100 km or more.

5. Three members of the same group kept the same travel history record.

6. Three members of the same group kept the same travel history record in at least two locations out of Tokyo, Nagoya and Kyoto and the total travel distance is 100 km or more.

7. The users kept travel history records in the order of Tokyo, Kyoto and Nagoya.

The details of services provided to the user and the period, location and numerical values of service providing conditions can be arbitrarily set by the service provider.

Next, a flow where by which the user uses the service providing system 1 to receive services will be described. In the following example, the service providing condition is the condition No. 6 described above and the service provided to the user when the condition is satisfied is discount of travel fee.

The three users A, C, D register their personal information with the service information management server 3 and register themselves as a same group. Next, they check the service providing conditions. On completion of registration, the three users A, C, D make personal authentication on the personal authentication apparatus 2 provided in Tokyo on Jan. 18, 2002. When the user A is authenticated as an authorized user A by the authentication section 20, travel history information including the date and time of authentication (Jan. 18, 2002), identification number indicating the location of authentication (identification number indicating Tokyo) and the user ID of the user A is transmitted to the travel history information receiver 35 from the travel history transmitter 21.

The travel history information received by the travel history information receiver 35 is stored into the column of the user A in the travel history information table 41 of the travel history information storage 31 via the controller 34. The user ID is used to determine which user corresponds to the received travel history information. Then, the users C, D perform the same operation and the travel history information of the users C, D is stored into the travel history information table 41 in the same way.

On the next day, the three users A, C, D travel to Kyoto and make personal authentication on the personal authentication apparatus 2 provided in Kyoto in the same way as the preceding step. In Kyoto, when the travel history information of the three users is stored into the travel history information table 41, the information stored in the travel history information table 41 is as shown in FIG. 4. The controller 34 references the service providing conditions stored in the service information storage 32 to determine whether the travel history information stored in the travel history information table 41 satisfies the service providing conditions.

In this example, three conditions are satisfied: the three users A, C, D belong to the same group, all the three members kept travel history records in Tokyo and Kyoto, and the distance from Tokyo and Kyoto which is based on the distance table is 100 km or more. Thus the controller 34 makes control to transmit the trip charge discount service information to the service information receiver 22 via the service information transmitter 33.

After that, the trip charge discount service information is received by the service information receiver 22 and output for example as trip charge discount tickets from the service information output section 23. The three members A, C, D acquire the trip charge discount tickets.

While the users A, C, D make a trip in this example, the service providing system 1 may be used for orienteering. When the service providing system 1 is used for orienteering, it is possible to monitor the travel history of participants in the orienteering thus preventing possible illegal actions and enhancing amusement of the game.

As mentioned earlier, according to this embodiment, travel history information such as the date/time and location the user was authenticated as an authorized user is stored into the information management server 3. In case the travel history information of the user has satisfied the conditions specified by the service provider, the service corresponding to the travel history information is provided to the user. The user enjoys the service by keeping a travel history record at the date/time and in the location specified by the service provider. The service provider can prompt the user to act as specified by the provider. It is thus possible to provide a service providing system which is advantageous to both the user and the service provider.

Finally, advantages assumed in case the aforementioned service providing conditions 1 through 7 are set are listed. The following numerals correspond to the service providing conditions 1 through 7.

1. The service provider can prompt the users to visit a specified location (Nagoya) within the specified period (from Jan. 1, 2002 to Jan. 31, 2002).

2. The service provider can prompt the users to visit a specified location (Kyoto) plural times (three times).

3. The service provider can prompt the users to visit a specified plurality of locations (Tokyo, Kyoto).

4. The service provider can prompt the users to make a trip beyond a specified distance (100 km).

5. The service provider can prompt a specified number of members of a user group (three members) to make a trip together.

6. The service provider can prompt a specified number of members of a user group (three members) to make a trip together as well as prompt the three members to travel over a longer distance.

7. The service provider can prompt the users to make a trip in the specified order (Tokyo, Kyoto, Nagoya).

According to the invention, it is possible to provide a service providing system which can provide services on a per user basis based on the travel history information indicating the location the user was present and the date/time the user was present.

What is claimed is:

1. A service providing system comprising:
a terminal comprising a travel history information transmission unit for transmitting travel history information and a service information output unit for outputting information on services in accordance with the travel history information; and
a server comprising a travel history information storage unit for storing the travel history information transmitted from the terminal, a service information storage unit for storing information on the services, and a service information transmission unit for transmitting information on the services to the terminal.

2. The service providing system according to claim 1, wherein the information on the service includes a presence proof service to prove location the user was present and the date/time the user was present.

3. The service providing system according to claim 1, wherein the service information transmission unit transmits information on the services to the terminal when the travel history information has satisfied the conditions specified by the provider of information on the services.

4. The service providing system according to claim 2, wherein the information on the service includes a presence proof service to prove location the user was present and the date/time the user was present.

5. The service providing system according to claim 1, wherein the travel history information of the user includes the location information the user has been present and the date/time the user has been present at the location.
